(19) United States
(12) Patent Application Publication
(10) Pub. No.: US 2012/0093478 A1
(43) Pub. Date: Apr. 19, 2012

(54) QUICK DISK PLAYER CONFIGURATION TO SEND CONTENT TO TV

(75) Inventor: Jesse Gallup, San Marcos, CA (US)

(73) Assignee: SONY CORPORATION

(21) Appl. No.: 12/904,490

(22) Filed: Oct. 14, 2010

(51) Int. Cl. H04N 5/775

(52) U.S. Cl. 386/230; 386/E05.003

(57) ABSTRACT

A hardware or software key is provided on a computer which, when selected, automatically establishes optimum disk player settings for a TV so that the content can be sent from a video disk engaged with the computer to the TV for optimal viewing with a minimum of steps.

### I. FIELD OF THE INVENTION

The present application relates generally to quick disk player configuration protocols to send disk content from a computer to a TV.

### II. BACKGROUND OF THE INVENTION

Content on video disks such as Blu-Ray® disks can be played on computers such as laptop computers. To play the content, the processor of the computer executes a disk player software application which configures presentation of the content appropriately for the computer display.

Content on the video disk can also be sent from the computer to a TV for display, which typically has superior display capabilities. However, as recognized herein, configuring the disk player for optimal presentation on the TV is not easy or intuitive and requires many steps. For one thing, many users do not know that in some protocols such as Blu-Ray, content cannot be played on both the computer and the TV simultaneously. Furthermore, the user must know which video and audio players settings are optimal for the TV and must then learn how to navigate through various user interface (UI) screens to establish these video and audio settings. As a result, users can become frustrated and may simply resign themselves to watching the content on the TV with less than optimal settings, e.g., with a lower resolution than they might otherwise be able to exploit, with a smaller picture size than the TV might otherwise support, and with poor audio.

### SUMMARY OF THE INVENTION

Accordingly, a device includes a processor in a housing, a video display controlled by the processor, and a receptacle in the housing configured to removably receive a video disk bearing audio video content. The processor, responsive to a selection signal generated by a user operating a HDMI key, automatically configures audio video content on the disk to have display settings fitting display capabilities of an audio video display device (AVDD) with which the processor communicates. The display settings include display resolution of the AVDD, the format of the AVDD, display overscan and number of audio channels. The format is an analog TV format or a digital format characterized by display aspect ratio, display scan type, and display refresh rate.

In some embodiments the processor, responsive to the selection signal, first determines whether the processor has communication on a link with the AVDD and responsive to determining it does not, the processor configures the content with a display profile tailored to the video display of the device and not to the AVDD. In contrast, responsive to a determination that the processor has communication on the link with the AVDD, the processor automatically configures audio video content on the disk to have display settings fitting display capabilities of the AVDD and not the device housing the processor.

If desired, the processor may, responsive to the selection signal, determine whether the selection signal has not been previously received and responsive to a determination that the selection signal has not been previously received the processor presents a user interface (UI) configured for prompting a user to confirm the display settings fitting display capabilities of the AVDD. On the other hand, responsive to a determination that the selection signal has been previously received, the processor can automatically configure audio video content on the disk to have display settings fitting display capabilities of the AVDD and not the device housing the processor.

The example UI in non-limiting embodiments includes an entry presenting information about display settings that are optimum for the AVDD. The display settings are discovered by the processor using information supplied by the AVDD. Further, an edit selector can be provided in the UI, selection of which enables a user, by means of an input device communicating with the processor, to enter replacement values in fields of the entry presenting information about display settings. A confirm selector can also be provided, selection of which causes the processor to automatically add values in the fields of the entry presenting information about display settings to a profile associated with the AVDD. Responsive to selection of the confirm selector the processor may also automatically configure audio video content on the disk to have display settings fitting display capabilities of the AVDD.

In example implementations, responsive to a selection signal generated by a user operating the HDMI key, the processor further automatically switches to an external (TV) display only mode. In this mode, content from a disk engaged with the receptacle is sent over the link to the AVDD and is not presented on the display of the device housing the processor. Furthermore, responsive to a selection signal generated by a user operating the HDMI key the processor may further send optimally formatted content from the disk to the AVDD for display thereof.

In another aspect, a method includes providing a hardware or software key on a computer which is selectable by a user to generate a select signal. The method also includes, responsive to the select signal, automatically establishing optimum display settings for a TV so that content from a video disk is sent from a computer engaged with the video disk to the TV for optimal viewing while minimizing user operations.

In another aspect, a device includes a processor in a housing, a video display controlled by the processor, and a receptacle in the housing configured to removably receive a video disk bearing audio video content. The processor, responsive to a selection signal generated by a user operating a single key, automatically configures audio video content on the disk to have display settings fitting display capabilities of an audio video display device (AVDD) with which the processor communicates. Also, the processor, responsive to the selection signal, determines whether the processor has communication on a link with the AVDD. Responsive to determining it does not, the processor configures the content with a display profile tailored to the video display of the device. However, responsive to a determination that the processor has communication on the link with the AVDD, the processor automatically configures audio video content on the disk to have display settings fitting display capabilities of the AVDD.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles, schematically showing interior components;

FIG. 2 is a screen shot of an example user interface (UI) that can be displayed when the HDMI key is pressed;

FIG. 3 is a screen shot of an example user interface (UI) that can be displayed to quickly set up a TV HDMI display profile; and

FIG. 4 is a flow chart of example logic for facilitating quick disk player configuration to send video disk content from a computer to a TV.

### DETAILED DESCRIPTION OF THE PREFERRED EMBODIMENT

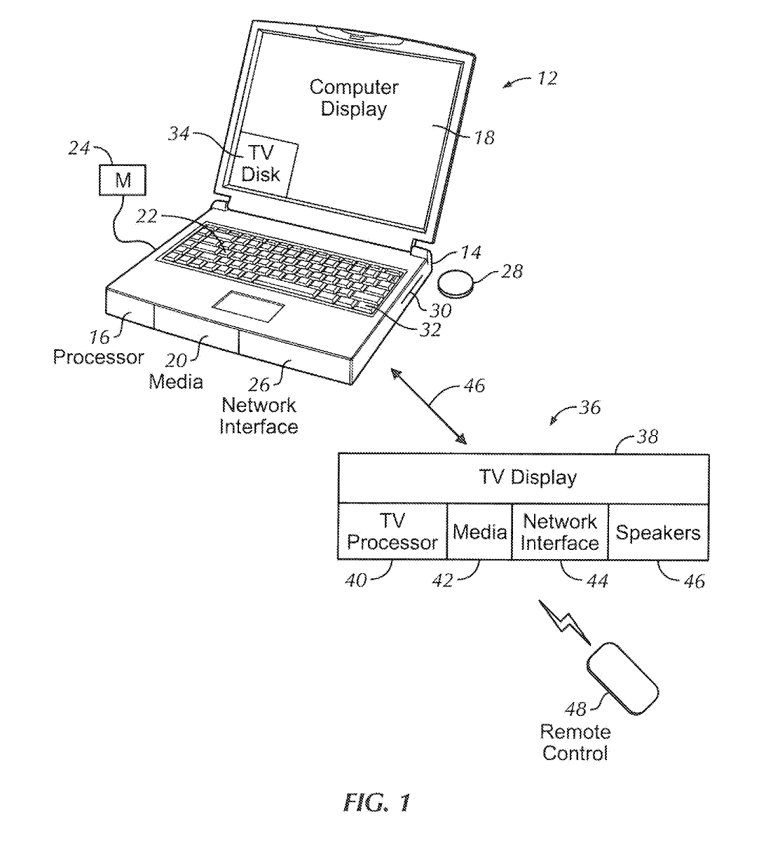

Referring initially to FIG. 1, a computing device 12 such as a personal digital assistant, laptop computer, personal computer (PC), etc. includes a housing 14 bearing a digital processor 16. The processor 16 can control a visual display 18 and an audible display such as one or more speakers. The processor 16 may access a video disk media player module one or more computer readable storage media 20 such as but not limited to RAM-based storage, a chip implementing dynamic random access memory (DRAM)) or flash memory or disk storage such that the device 12 has media decoding capability. Software code implementing present logic executable by the device 12 may be stored on one of the memories shown to undertake present principles.

The processor 16 can receive user input signals from various input devices, including a keyboard or keypad 22 (hereinafter “keypad” without loss of generality), a point and click device such as a mouse 24 or joystick, etc. A network interface 26 such as a high definition multimedia interface (HDMI) can be provided to enable the processor 14 to communicate with another HDMI-compliant component.

As also shown in FIG. 1, the processor 14 accessing the video disk module can receive and decode content for play from a video disk 28 engageable with a disk receptacle 30 of the computer. In an example embodiment the disk 28 is a Blu-Ray disk.

According to present principles, a special key (hereinafter “HDMI key” without loss of generality) is provided which, when selected, causes the processor 14 executing the video disk module to automatically configure content for presentation on a display other than the computer display 18, as discussed more fully below. In one example, the HDMI key is implemented by a hardware key 32 on the computer that may be a special purpose function key, for example, on the keypad 22. Or, the HDMI key may be implemented by a software key represented by an image 34 of the key that can be presented on the display 18 and selected by means of the mouse 24.

FIG. 1 shows that the computer 12 can communicate with an audio video display device (AVDD) that can present audio and video content. In an example embodiment the AVDD is instantiated by a TV 36 such as but not limited to a flat panel matrix-type TV having a high definition TV display 38 controlled by a TV processor 40 accessing a TV storage medium 42. The TV has a network interface 44 that can communicate with the interface 26 of the computer 12 via a link 46 such as, e.g., a HDMI cable or a wireless HDMI link (which may include ancillary HDMI-related channels such as consumer electronic control (CEC) channels). The TV processor 40 can also control audio presentation on one or more TV speakers 46 and can receive user commands from a wireless remote control (RC) 48. In some embodiments the HDMI key can be instantiated on the TV and the TV processor 40 can coordinate with the computer processor 14 to undertake present principles pursuant to its selection.

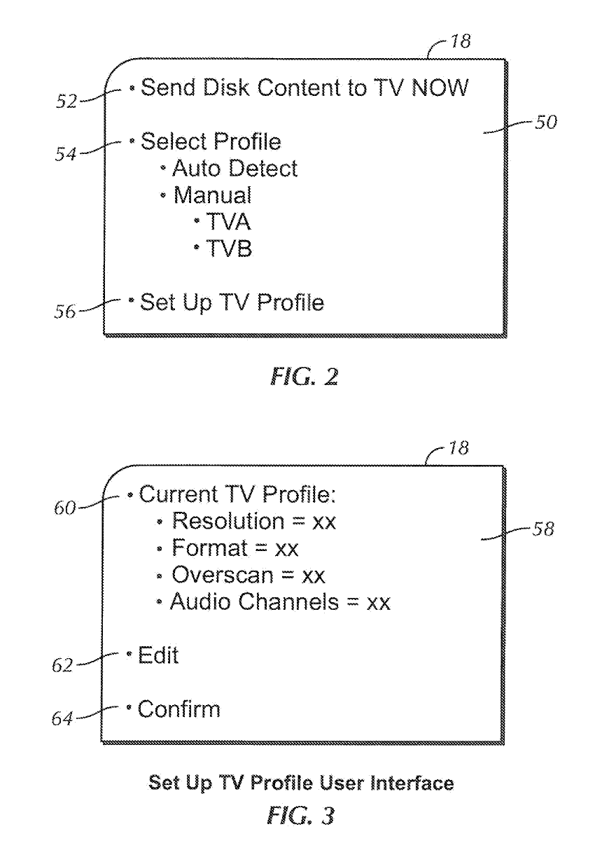

FIG. 2 shows an example UI 50 that may be presented on the computer display 18 by the processor 14 responsive to selection of the HDMI key. As shown, the user may be presented with an option 52 to immediately send disk content to the TV, implicitly using optimum settings. Portions of the logic of FIG. 4, described further below, are executed responsive to selection of the option 52 to configure the content for the TV 36 without further user input being required.

Also, an option 54 may be presented allowing the user to select a TV settings profile either by automatically detecting the identity of the TV 36 using, e.g., enhanced display identification data (EDID) received over the link 46 and matching the identity with a previously stored profile, or manually selecting a profile from a list of previously stored profiles (e.g., “TV A” and “TV B”.) Selection of a profile automatically functions to configure content settings accordingly and for the logic to follow the appropriate steps of FIG. 4 without further user input required.

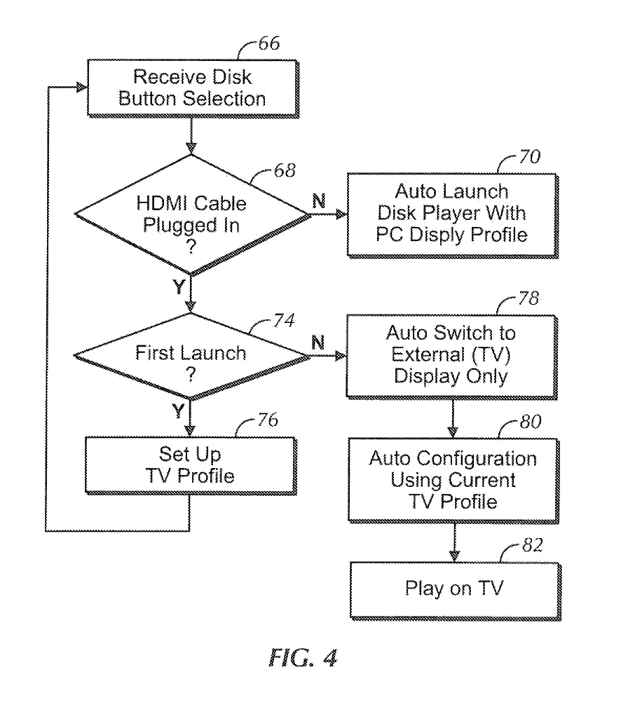

Still further, if desired an option 56 may be presented which, when selected by the user, invokes the UI of FIG. 3 to allow a user, with minimal input required, to establish a profile for the TV 36. Accordingly and turning now to the UI 58 of FIG. 3, at entry 60 the user is presented with information about the particular content settings that are optimum with the TV 36. These settings are discovered by the computer processor 14 using information supplied by the TV processor 40 over the link 46 in response to, e.g., a query for EDID data. As shown in FIG. 3, the user can be presented with the display resolution of the TV 36, the format of the TV. By “format” is meant for analog TVs, whether the TV is in phase alternate line (PAL) and which variation thereof variations, national television system committee (NTSC) format and which variation thereof, or sequential color with memory (SECAM) format. For digital TVs the format refers to the TV's digital television (DTV) format number, with DTV formats generally distinguishable from each other based on one or more of aspect ratio, scan type, refresh rate, and type, i.e., standard definition, high definition, or enhanced definition.

The settings presented on the UI 58 also include the display overscan, if any, of the TV 36, and the number of audio channels. A TV may require two audio channels, for instance, but if part of a home sound system additional audio channels may be used.

If the user wishes to edit any of the discovered settings presented at 60, an edit selector 62 is presented, selection of which using, e.g., the mouse 24 enables a user, by means of the keypad 22, to enter other values in the fields of 60 denoted in FIG. 3 by “xx”. If the user wishes to accept or confirm the discovered settings, however, the user need simply select a confirm selector 64. Selection of the confirm selector 64 automatically adds the profile indicated at 60 to those which may be selected by means of the option 54 in FIG. 2 and also causes the processor 14 to automatically execute the below-described automatic configuration for the profile.

FIG. 4 shows example logic that may be implemented by the processor 14 in accordance with present principles. At block 66 a selection input signal is received responsive to the user clicking on or pressing the HDMI key. The logic may first flow to decision diamond 68 wherein the processor 14 determines whether it communicates over the link 46, typically by determining whether an HDMI cable is plugged in. If not, the logic flows to block 70 to automatically launch the disk player software using the display settings profile of the computer 12.

On the other hand, if the test at decision diamond 68 is positive, in some embodiments the logic may flow to decision diamond 74 to determine whether this is the first time launch of the HDMI key, and if it is, the UI 58 of FIG. 3 may be presented to set up the TV profile. The logic may then loop back to block 66 wherein a second click of the HDMI key would cause the logic to flow to block 78. Also, a negative test at decision diamond 74 causes the logic to flow to block 78. It is to be understood that when a UI such as the UI 50 shown in FIG. 2 is provided responsive to a first click of the HDMI key, the logic of states 74 and 76 in FIG. 4 may be omitted since their functionality is already provided for, with a positive test at decision diamond 68 causing the logic to flow to block 78. Similarly, the UI 50 in FIG. 2 may be omitted and a click of the HDMI key can invoke the entire logic shown in FIG. 4.

At block 78, the processor 14 automatically switches to an external (TV) display only mode, in which content from a disk 28 engaged with the computer 12 is sent over the HDMI link 46 to the TV 36 and is not presented on the computer display 18, in accordance with the above observation that some disks such as Blu-Ray permit presentation only on a single display at a time. The logic then moves to block 80 in which the processor 14 processes the content from the disk into the required profile settings for the current TV profile. At block 82 the optimally formatted content is presented on the TV display 38 and TV speakers 46 according to the settings shown in FIG. 3 and established at block 76 or using the UI of FIG. 2.

While the particular QUICK DISK PLAYER CONFIGURATION TO SEND CONTENT TO TV is herein shown and described in detail, it is to be understood that the subject matter which is encompassed by the present invention is limited only by the claims.

What is claimed is:

1. Device comprising:
processor in a housing;
video display controlled by the processor; and
receptacle in the housing configured to removably receive a video disk bearing audio video content, the processor, responsive to a selection signal generated by a user operating a HDMI key, automatically configuring audio video content on the disk to have display settings fitting display capabilities of an audio video display device (AVDD) with which the processor communicates, the display settings including display resolution of the AVDD, the format of the AVDD, the format being an analog TV format or a digital format characterized by at least display aspect ratio, display scan type, display refresh rate, the display settings also including display overscan and number of audio channels.

2. The device of claim 1, wherein the processor responsive to the selection signal determines whether the processor has communication on a link with the AVDD and responsive to determining it does not, the processor configures the content with a display profile tailored to the video display of the device and not to the AVDD, and responsive to a determination that the processor has communication on the link with the AVDD, the processor automatically configures audio video content on the disk to have display settings fitting display capabilities of the AVDD and not the device housing the processor.

3. The device of claim 1, wherein the processor responsive to the selection signal determines whether the selection signal has not been previously received and responsive to a determination that the selection signal has not been previously received the processor presents a user interface (UI) configured for prompting a user to confirm the display settings fitting display capabilities of the AVDD, and responsive to a determination that the selection signal has been previously received the processor automatically configures audio video content on the disk to have display settings fitting display capabilities of the AVDD and not the device housing the processor.

4. The device of claim 3, wherein the UI includes an entry presenting information about display settings that are optimum for the AVDD, the display settings being discovered by the processor using information supplied by the AVDD.

5. The device of claim 4, wherein the UI further comprises an edit selector selection of which enables a user, by means of an input device communicating with the processor, to enter replacement values in fields of the entry presenting information about display settings and a confirm selector, selection of which causes the processor to automatically add values in the fields of the entry presenting information about display settings to a profile associated with the AVDD.

6. The device of claim 5, wherein responsive to selection of the confirm selector the processor automatically configures audio video content on the disk to have display settings fitting display capabilities of the AVDD.

7. The device of claim 1, wherein responsive to a selection signal generated by a user operating the HDMI key the processor further automatically switches to an external (TV) display only mode, in which content from a disk engaged with the receptacle is sent over the link to the AVDD and is not presented on the display of the device housing the processor.

8. The device of claim 1, wherein responsive to a selection signal generated by a user operating the HDMI key the processor further sends optimally formatted content from the disk to the AVDD for display thereof.

9. The device of claim 1, wherein the AVDD is a TV.

10. Method comprising:
providing a hardware or software key on a computer which is selectable by a user to generate a select signal; and
responsive to the select signal, automatically establishing optimum display settings for a TV so that content from a video disk is sent from a computer engaged with the video disk to the TV for optimal viewing while minimizing user operations.

11. The method of claim 10, wherein the display settings include display resolution of the TV, the format of the TV, the format being an analog TV format or a digital format characterized by at least display aspect ratio, display scan type, display refresh rate, the display settings also including display overscan and number of audio channels.

12. The method of claim 11, wherein the method further includes responsive to the select signal determining whether communication is established on a link with a computer and the TV and responsive to determining it does not, configuring the content with a display profile tailored to a video display of the computer, and responsive to a determination that communication is established on the link, the method includes automatically configuring audio video content on the disk to have display settings fitting display capabilities of the TV.

13. The method of claim 11, wherein the method includes responsive to the select signal determining whether the select signal has not been previously received and responsive to a determination that the select signal has not been previously received the method includes presenting a user interface (UI) configured for prompting a user to confirm the display settings fitting display capabilities of the TV, and responsive to a determination that the select signal has been previously received the method includes automatically configuring audio video content on the disk to have display settings fitting display capabilities of the TV.

14. The method of claim 13, wherein the UI includes an entry presenting information about display settings that are optimum for the TV, the display settings being discovered by the processor using information supplied by the TV.

15. The method of claim 14, wherein the UI further comprises an edit selector selection of which enables a user to enter replacement values in fields of the entry presenting information about display settings and a confirm selector, selection of which causes a processor to automatically add values in the fields of the entry presenting information about display settings to a profile associated with the TV.

16. The method of claim 15, wherein responsive to selection of the confirm selector the method includes automatically configuring audio video content on the disk to have display settings fitting display capabilities of the TV.

17. The method of claim 10, wherein responsive to a selection signal generated by a user operating the key the method includes further automatically switching to an external (TV) display only mode, in which content from a disk engaged with the receptacle is sent over the link to the TV and is not presented on display of a device engaged with the disk.

18. The method of claim 10, wherein responsive to a selection signal generated by a user operating the key the method includes sending optimally formatted content from the disk to the TV for display thereof.

19. Device comprising:
processor in a housing;
video display controlled by the processor; and
receptacle in the housing configured to removably receive a video disk bearing audio video content, the processor, responsive to a selection signal generated by a user operating a single key, automatically configuring audio video content on the disk to have display settings fitting display capabilities of an audio video display device (AVDD) with which the processor communicates, wherein the processor responsive to the selection signal determines whether the processor has communication on a link with the AVDD and responsive to determining it does not, the processor configures the content with a display profile tailored to the video display of the device, and responsive to a determination that the processor has communication on the link with the AVDD, the processor automatically configures audio video content on the disk to have display settings fitting display capabilities of the AVDD.

20. The device of claim 19, wherein the processor responsive to the selection signal determines whether the selection signal has not been previously received and responsive to a determination that the selection signal has not been previously received the processor presents a user interface (UI) configured for prompting a user to confirm the display settings fitting display capabilities of the AVDD, and responsive to a determination that the selection signal has been previously received the processor automatically configures audio video content on the disk to have display settings fitting display capabilities of the AVDD and not the device housing the processor.
